(19) United States
(12) Patent Application Publication
(10) Pub. No.: US 2025/0218759 A1
(43) Pub. Date: Jul. 3, 2025

(54) VACUUM SYSTEM AND VALVE ASSEMBLY FOR A MASS SPECTROMETER

(71) Applicant: Thermo Finnigan LLC, San Jose, CA (US)

(72) Inventors: George B. Guckenberger, Austin, TX (US); Nicholas A. Pedrazas, Austin, TX (US)

(21) Appl. No.: 18/402,475

(22) Filed: Jan. 2, 2024

(51) Int. Cl. H01J 49/24; H01J 49/04; H01J 49/26

(52) U.S. Cl. CPC H01J 49/24; H01J 49/0495; H01J 49/26

(57) ABSTRACT

A vacuum system for a mass spectrometer includes a first vacuum region, a second vacuum region, a vacuum interlock fluidly connected to the vacuum chamber by a first valve, a first pump fluidly connected to the first and second vacuum regions, a second pump fluidly connected to the second vacuum region, and a second valve. The second valve includes a housing, a piston movable within the housing between an evacuation position and an operation position, a first channel connected to a third valve, a second channel connected to the vacuum interlock, a third channel connected to the first pump, and a fourth channel connected to the second vacuum region. In response to the third valve adjusting to a first position, the piston moves to the evacuation position. In response to the third valve adjusting to the second position, the piston moved to the opened position.

### FIELD

The present disclosure relates to mass spectrometers. More specifically, the present disclosure relates to a vacuum system including an improved isolation valve assembly to evacuate a vacuum interlock in a mass spectrometer.

### BACKGROUND

Mass spectrometers include high vacuum pumps that operate at low pressures. Exposure to large pressure differentials can lead to damage of the high vacuum pumps. In addition, when evacuating a mass spectrometer vacuum interlock, the vacuum system is exposed to pressures that can create large pressure differentials. Efforts to avoid these pressure differentials can result in a time-consuming evacuation cycle. Accordingly, there is an opportunity to improve mass spectrometers by limiting exposure of the high vacuum pumps to large pressure differentials while avoiding a time-consuming evacuation cycle.

### SUMMARY

In one example of an embodiment, a vacuum system for a mass spectrometer includes a first vacuum region, a second vacuum region, a vacuum interlock fluidly connected to the vacuum chamber by a first valve, a first pump fluidly connected to the first and second vacuum regions, a second pump fluidly connected to the second vacuum region, and a second valve. The first pump is configured to decrease a pressure within the first vacuum region. The first pump is configured to exhaust air to the second vacuum region. The second pump is configured to decrease a pressure within the vacuum interlock. The second valve includes a housing, a piston movable within the housing between an evacuation position and an opened position, a first channel extending through the housing and fluidly connected to a third valve, a second channel extending through the housing and fluidly connected to the vacuum interlock, a third channel extending through the housing and fluidly connected to the first pump, and a fourth channel extending through the housing and fluidly connected to the second vacuum region. The third valve is adjustable between a first position and a second position. The third valve is fluidly connected to atmospheric air in the first position. The third valve is fluidly connected to the second vacuum region in the second position. In response to the third valve adjusting to the first position, the piston moves to the evacuation position, the second channel is fluidly connected to the fourth channel, and the third channel is fluidly isolated from the first, second, and fourth channels. In response to the third valve adjusting to the second position, the piston moves to the opened position, the third channel and the fourth channel are fluidly connected, and the third channel is fluidly isolated from the first and second channels.

In another example of an embodiment, a valve assembly includes a housing having a body and a cap coupled to the body, a piston movable within the housing between an evacuation position and an opened position, a first channel extending through the cap, a second channel extending through the body, a third channel extending through the body, and a fourth channel extending through the body. In response to the piston moving to the evacuation position, the second channel is fluidly connected to the fourth channel, and the third channel is fluidly isolated from the first, second, and fourth channels. In response to the piston moving to the opened position, the third channel and the fourth channel are fluidly connected, and the third channel is fluidly isolated from the first and second channels.

Other aspects of the invention will become apparent by consideration of the detailed description and accompanying drawings.

### BRIEF DESCRIPTION OF THE DRAWINGS

FIG. 1 is a schematic view of a mass spectrometer including an embodiment of a vacuum system with an improved isolation valve assembly.

FIG. 2 is a perspective view of the isolation valve assembly of FIG. 1 illustrating a first end of the isolation valve assembly.

FIG. 3 is a perspective view of the isolation valve assembly of FIG. 2 illustrating a second end of the isolation valve assembly opposite the first end.

FIG. 4 is an exploded view of the isolation valve assembly of FIG. 2 viewed from a first side of the isolation valve assembly and illustrating the first end of the isolation valve assembly.

FIG. 5 is an exploded view of the isolation valve assembly of FIG. 2 viewed from the first side of the isolation valve assembly and illustrating the second end of the isolation valve assembly.

FIG. 6 is a perspective view of a body of the isolation valve assembly of FIG. 2.

FIG. 7 is a cross-sectional view of the isolation valve assembly in an opened position taken along line A-A in FIG. 2, with fluid connectors coupled to the isolation valve assembly, and a control valve in communication with the isolation valve assembly.

FIG. 8 is a cross-sectional view of the isolation valve assembly in the opened position taken along line B-B in FIG. 2.

FIG. 9 is a cross-sectional view of the isolation valve assembly in a sealed position taken along line A-A in FIG. 2.

FIG. 10 is a cross-sectional view of the isolation valve assembly in the sealed position taken along line B-B in FIG. 2.

FIG. 11 is a cross-sectional view of the isolation valve assembly in an evacuation position taken along line A-A in FIG. 2.

FIG. 12 is a cross-sectional view of the isolation valve assembly in the evacuation position taken along line B-B in FIG. 2.

FIG. 13 is a flow diagram providing an example of operational steps of the mass spectrometer of FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or being carried out in various ways.

### DETAILED DESCRIPTION

Systems and methods described herein include an isolation valve assembly to reduce pressure surge that can be damaging to high vacuum pumps and reduce the wait time of users in evacuating volumes in instruments such as mass spectrometers. In certain instruments, a high vacuum pump backed by a low vacuum pump is used to evacuate one or more regions (e.g., chambers) in the instrument. To reduce power consumption and costs, the same low vacuum pump is often also employed to evacuate an interlock that is fluidly connected to the high vacuum region to enable, for example, insertion and removal of samples into the instrument. In conventional systems, pumping down the pressure (usually atmospheric pressure) in the interlock using the low vacuum pump can endanger the high vacuum pump because the high vacuum pump must operate below a designated pressure threshold at its exit (or exhaust) to maintain mechanical stability and protect from catastrophic failure or excessive wear and decreased lifespan. The sudden shock of atmospheric pressure air from the interlock at the exit to the high vacuum pump (i.e., at the entrance of the low vacuum pump) can thus threaten to raise the pressure at the exit of the high vacuum pump over the threshold. The isolation valve assembly taught herein eliminates the possibility of experiencing overpressure at the exit of the high vacuum pump by cleanly isolating and reconnecting the high vacuum pump and the low vacuum pump during evacuation of the interlock as a result of motion of a single piston powered by pressure at a control valve.

In some conventional systems, pressure shock from air in the interlock was controlled by adding pre-evacuated expansion volumes or flow restrictors between the interlock volume and the low pressure pump. These elements operate by restricting flow or introducing additional volumes. In either instance, the total amount of pumping time that a user must wait to establish high vacuum conditions is increased because of the increased time to pump out the large expansion volume or the slow speed of pumping through the restriction. The isolation valve assembly taught herein in accordance with some embodiments enables fast pumping and reduction of total pumping time by including large, high-conductance air pathways that are opened or sealed according to the desired experimental stage.

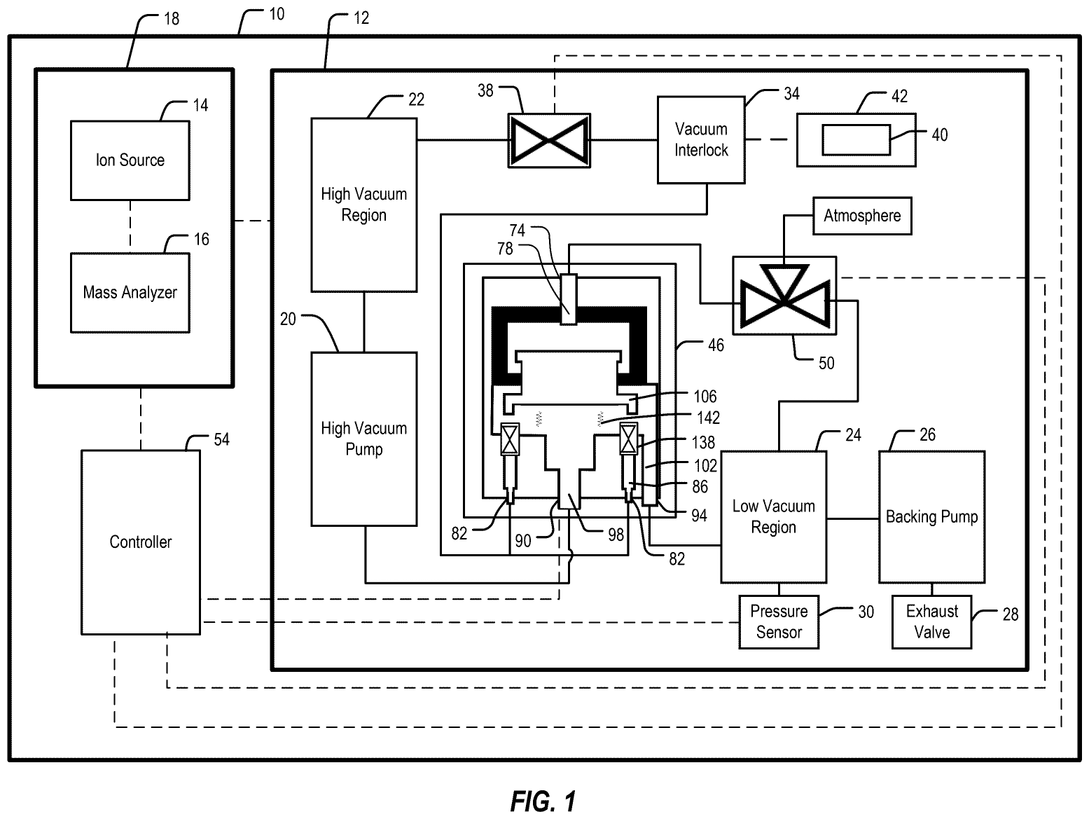

FIG. 1 illustrates a schematic diagram of an example of an embodiment of a mass spectrometer 10. The mass spectrometer 10 includes a vacuum system 12. The vacuum system 12 is in fluid communication with an ion source 14. The ion source 14 is in fluid communication with a mass analyzer 16. The ion source 14 and the mass analyzer 16 and generally known components of the mass spectrometer 10 within the vacuum system 12 are represented herein by a box 18. The vacuum system 12 includes a high vacuum pump 20 (also referred to as a first pump 20) that is fluidly connected to a high vacuum region 22 and a low vacuum region 24. The high vacuum region 22 can also be referred to as a first vacuum region 22, while the low vacuum region 24 can also be referred to as a second vacuum region 24 (or a rough vacuum region 24). The high vacuum pump 20 is configured to generate a first vacuum (e.g., a pressure less than 10⁻⁴ Torr, a pressure less than 3×10⁻⁵ Torr, etc.) within the high vacuum region 22. The high vacuum pump 20 is also configured to exhaust gas into the low vacuum region 24. The high vacuum pump 20 can be any suitable vacuum pump for generating the targeted vacuum in the high vacuum region 22, including but not limited to, a multi-stage turbomolecular pump, a diffusion pump, etc.

A backing pump 26 (also referred to as a second pump 26 or a low vacuum pump 26) is fluidly connected to the low vacuum region 24. The backing pump 26 is configured to evacuate exhaust from the high vacuum pump 20. The backing pump 26 generates a second vacuum within the low vacuum region 24. The second vacuum is a lesser vacuum than the first vacuum (i.e., the second vacuum has a higher pressure than the first vacuum). As a nonlimiting example, the backing pump 26 can generate a second vacuum having a pressure less than 5 Torr, a pressure less than 200 millitorr (mTorr), etc. The backing pump 26 includes an exhaust valve 28. The backing pump 26 is configured to exhaust air from the low vacuum region 24 into the surrounding atmosphere through the exhaust valve 28. A pressure sensor 30 is in operable communication with the low vacuum region 24. The pressure sensor 30 is configured to detect a pressure within the low vacuum region 24. The pressure within the low vacuum region 24 can also referred to as a backing pressure.

A vacuum interlock 34 is selectively fluidly connected to the high vacuum region 22 by a high vacuum valve 38 (also referred to as a first valve 38). The high vacuum valve 38 can be, for example, a ball valve, a gate valve, or any other suitable valve. For example, the high vacuum valve 38 can be opened to transfer a sample 40 (or a mechanical assembly 40) to the high vacuum region 22. The sample 40 can be an analytical sample to be measured. The mechanical assembly 40 can be a cartridge of the ion source 14, a source plug, or any other component of the mass spectrometer 10 that can be exchanged to facilitate maintenance operations. For example, the high vacuum valve 38 can be opened to exchange the cartridge of the ion source 14. The cartridge of the ion source 14 can be exchanged to remove dirty (used) components of the ion source 14 and insert clean (new) components of the ion source 14. The cartridge of the ion source 14 can also be exchanged to change ionization volumes to allow for a different ionization technique (e.g., electron ionization, chemical ionization, etc.). The source plug can be exchanged to, for example, seal a transfer line of a gas chromatograph to allow a column of the gas chromatograph to be exchanged. The sample 40 can be positioned within a tool 42 (also referred to as a source exchange tool 42 or a sample probe 42). The tool 42 is configured to be coupled to the vacuum interlock 34. The tool 42 is selectively extendable. For example, in response to opening the high vacuum valve 38, the tool 42 is configured to extend into the high vacuum region 22 to insert the sample 40 (or the mechanical assembly 40) into the high vacuum region 22.

The vacuum interlock 34 is additionally selectively fluidly connected to the low vacuum region 24 by an isolation valve assembly 46 (also referred to as a second valve 46). The isolation valve assembly 46 selectively fluidly connects the vacuum interlock 34, the low vacuum region 24, and the high vacuum pump 20. The isolation valve assembly 46 is further fluidly connected to a control valve 50 (also referred to as a third valve). The illustrated control valve 50 is a three-way valve. The three-way control valve 50 selectively fluidly connects the isolation valve assembly 46 with atmosphere (external air at atmospheric pressure) or with the low vacuum region 24, which is described in further detail below.

With continued reference to FIG. 1, a controller 54 is configured to communicate with a plurality of components of the vacuum system 12. For example, the controller 54 is in communication with the high vacuum valve 38 and the isolation valve assembly 46. The controller 54 is configured to open and/or close each of the high vacuum valve 38 and the isolation valve assembly 46. As another example, the controller 54 is in communication with the pressure sensor 30 and is configured to receive pressure measurements in the low vacuum region 24 detected by the pressure sensor 30. As yet another example, the controller 54 is in communication with the control valve 50 to fluidly connect the isolation valve assembly 46 with either the atmosphere or the low vacuum region 24. The controller 54 is also configured to be in communication with other components (e.g., the ion source 14, the mass analyzer 16, and other known components 18) of the mass spectrometer 10 to facilitate operation of the mass spectrometer 10. The controller 54 can also be used to send a signal to a user (i.e., an audio or visual signal such as through a graphical interface) to manually adjust the high vacuum valve 38, the isolation valve assembly 46, or the control valve 50 in the case that the respective valve 38, 46, 50 is not electronically controlled. In some examples, the controller 54 is configured to read measurements from the pressure sensor 30 at a rate in the range of 5-10 Hertz.

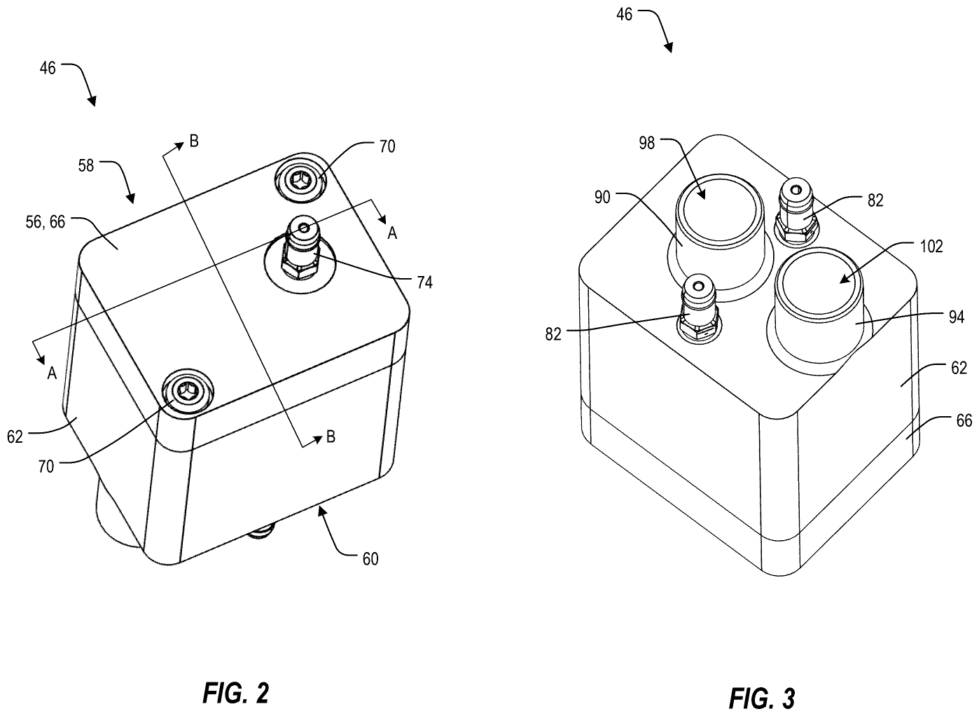

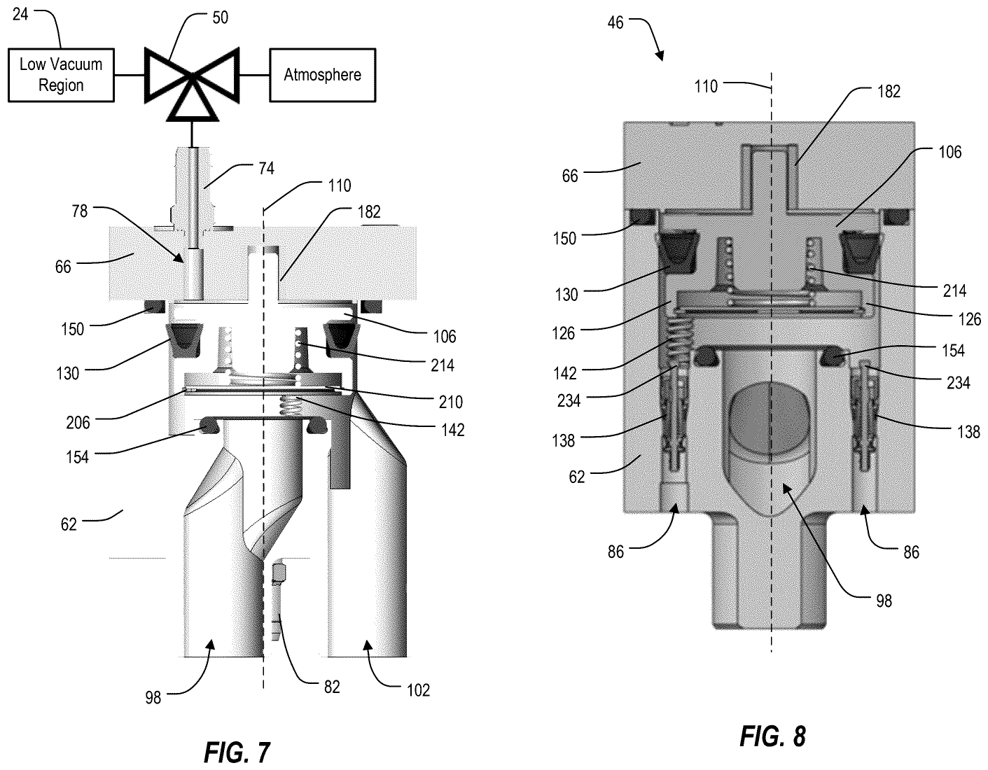

With reference now to FIG. 2, the isolation valve assembly 46 includes a housing 56 having a first end 58 and an opposing second end 60. The housing 56 includes a body 62 (or valve body 62) and a cap 66 (or a valve cap 66). The cap 66 is coupled to the body 62 by a plurality of fasteners 70 (e.g., screws, bolts, etc.). The illustrated isolation valve assembly 46 includes two fasteners 70. In other examples of embodiments, the isolation valve assembly 46 can include a single fastener 70, a plurality of fasteners 70, or three or more fasteners 70 (e.g., one, three, etc.). A first port 74 (also referred to as a first fluid connector 74) is coupled to the cap 66. The first port 74 is fluidly connected to a first channel 78 within the cap 66 (shown in FIG. 7).

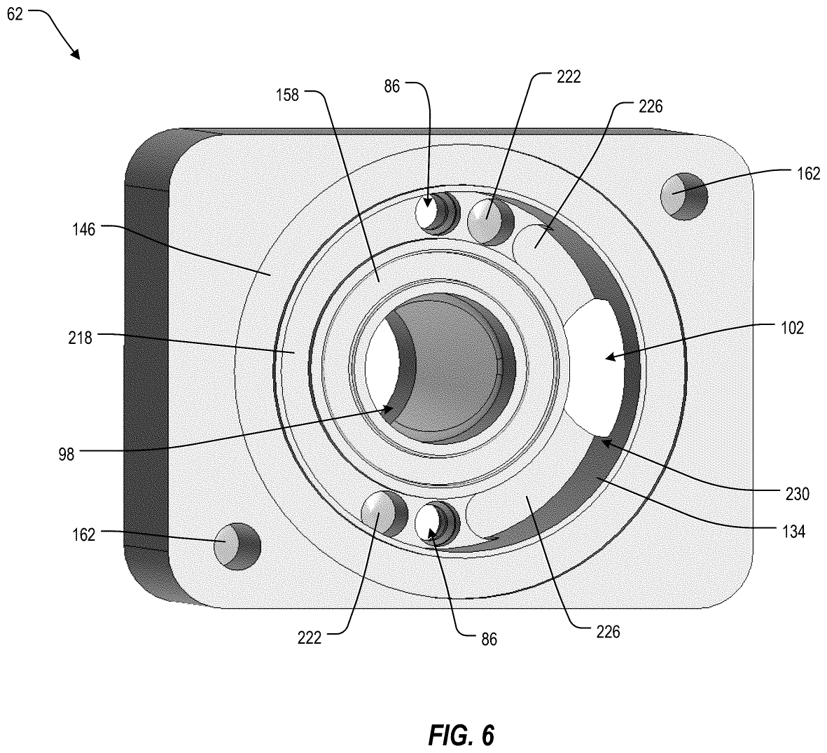

With reference now to FIG. 3, a pair of second ports 82 (also referred to as second fluid connectors 82) extend from the body 62 of the isolation valve assembly 46. Each of the second ports 82 is fluidly connected to a respective second channel 86 (shown in FIG. 6). Accordingly, the isolation valve assembly 46 include a pair of second channels 86. A third port 90 and a fourth port 94 also extend from the body 62. The third port 90 defines a third channel 98. The fourth port 94 defines a fourth channel 102. The third port 90 can also be referred to as a high vacuum port 90, and the third channel 98 can also be referred to as a high vacuum channel 98. The fourth port 94 can also be referred to as a backing port 94, and the fourth channel 102 can also be referred to as a backing channel 102. In the illustrated embodiment, both the high vacuum port 90 and the backing port 94 are integrally formed with the body 62 as a single monolithic component. In other examples of embodiments, the high vacuum port 90 and the backing port 94 can be coupled to the body 62.

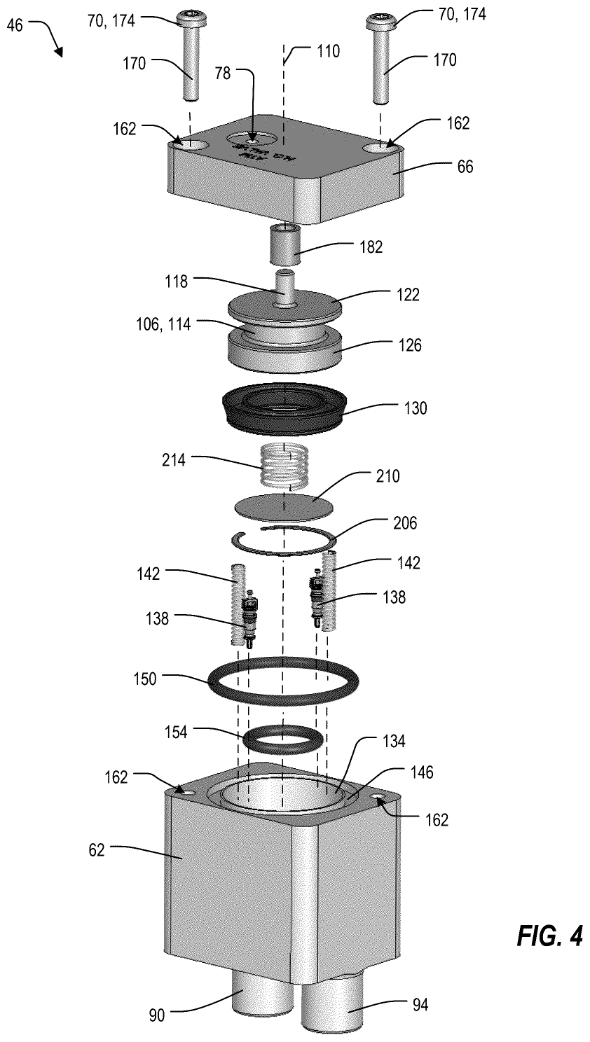

With reference now to FIG. 4, the isolation valve assembly 46 includes a piston 106 movable along a central axis 110. The piston 106 includes a piston body 114 and a stem 118. The stem 118 extends from the piston body 114 along the central axis 110. A first flange 122 (also referred to as an upper radial flange 122) and a second flange 126 (also referred to as a lower radial flange 126) extend radially outward from the piston body 114. A first gasket 130 (also referred to as a piston gasket 130) is positioned between the first and second flanges 122, 126 (as shown in FIG. 7). The piston gasket 130 creates a seal with a bore 134 defined by the body 62. The bore 134 can also be referred to as a valve bore 134 or a central bore 134, though the bore 134 is not limited to a central position within the body 62. The piston gasket 130 is configured to create a seal between the first channel 78 and the second, third, and fourth channels 86, 98, 102 (shown in FIG. 6). Because of the seal of the piston gasket 130, the first channel 78 is fluidly isolated from the second, third, and fourth channels 86, 98, 102 regardless of the position of the piston 106. In some embodiments, the piston gasket 130 can be replaced by a gasket (or a plurality of gaskets) positioned in the bore 134. An evacuation valve 138 (also referred to as a fourth valve 138) is received by each second channel 86 (shown in FIG. 8). Accordingly, each second channel 86 (shown in FIG. 8) receives a respective evacuation valve 138. In the illustrated embodiment, the isolation valve assembly 46 includes a pair of evacuation valves 138, one positioned within each of the second channels 86 (shown in FIG. 8). The evacuation valves 138 are adjusted between an opened position (or an evacuation configuration) (shown in FIG. 12) and a closed position (or a closed configuration) (shown in FIG. 8). Each evacuation valve 138 can be, as a nonlimiting example, a Schrader valve. In some embodiments, the piston 106 can include one or more additional seals in place of the evacuation valves 138. In these embodiments, the seals can be selectively positioned in the second channels 86 to open and/or close the second channels 86 in response to movement of the piston 106. At least one piston biasing member 142 is positioned within the valve bore 134. As illustrated, a plurality of piston biasing members 142, and more specifically a pair of piston biasing members 142 are positioned within the valve bore 134. The piston biasing members 142 are configured to bias the piston 106 away from the high vacuum port 90 by application of a biasing force, which is discussed in further detail below. The valve body 62 can define a body groove 146. The body groove 146 is configured to receive a housing gasket 150 (also referred to as a second gasket 150). The housing gasket 150 forms a seal between the body 62 and the cap 66 in response to the cap 66 being fastened to the body 62. A high vacuum gasket 154 (also referred to as a third gasket 154) is received in a high vacuum groove 158 (shown in FIG. 6). The high vacuum groove 158 is recessed into the valve body 62 relative to the body groove 146. Each fastener 70 is received in a body fastener aperture 162 and a cap fastener aperture 166. Each body fastener aperture 162 extends into the body 62. Each cap fastener aperture 166 extends through the cap 66. Each cap fastener aperture 166 is configured to align with a corresponding body fastener aperture 162, with aligned apertures 162, 166 configured to receive a fastener 70. Each body fastener aperture 162 can be threaded to receive a threaded portion 170 of each fastener 70. Each cap fastener aperture 166 can include a counterbore to receive a head portion 174 of each fastener 70.

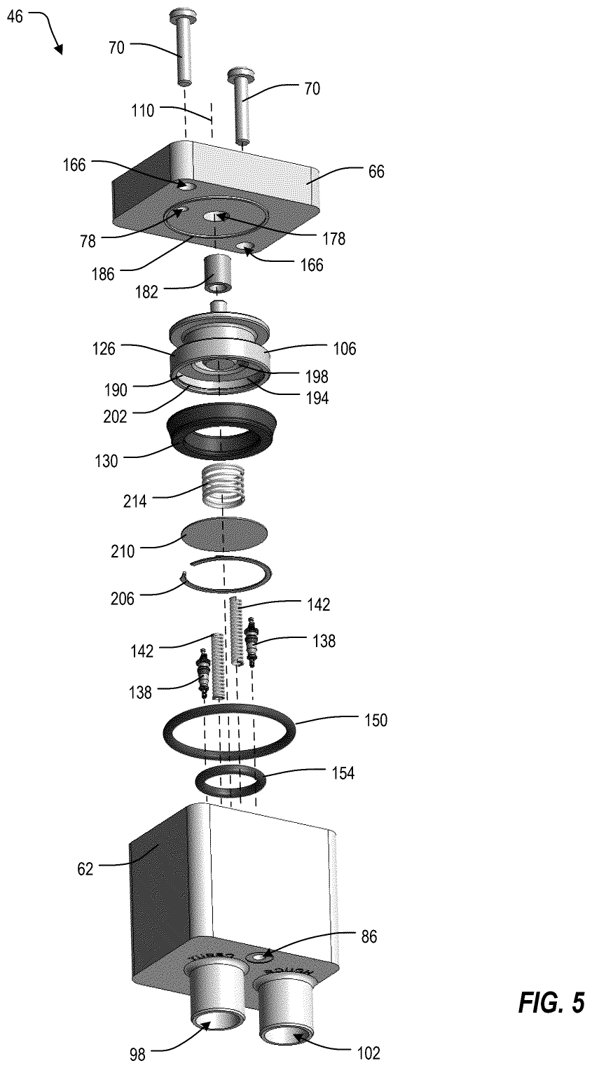

With reference now to FIG. 5, the cap 66 includes a retaining bore 178. The retaining bore 178 extends into a side of the cap 66 adjacent the body 62. A guide bushing 182 is received by (or positioned within) the retaining bore 178. The guide bushing 182 receives the stem 118 of the piston 106. The guide bushing 182 is configured to align the piston 106 to allow the piston 106 to move along the central axis 110. In embodiments with a gasket (or a plurality of gaskets) positioned in the valve bore 134, the guide bushing 182 can be omitted, as the gasket in the valve bore 134 can facilitate alignment of the piston 106. The cap 66 also includes an annular projection 186 on the side of the cap 66 adjacent the body 62. The annular projection 186 extends around and is concentric with the retaining bore 178. The housing gasket 150 engages the annular projection 186 to improve the seal between the body 62 and the cap 66. The piston 106 includes a piston recess 190 (also referred to as a piston cavity 190). The piston recess 190 includes a first portion 194 (also referred to as a countersink 194) and a second portion 198 (also referred to as a radial recess 198). The radial recess 198 extends from the countersink 194 in a direction away from the countersink 194 along the central axis 110. A radial groove 202 extends around a periphery of the countersink 194. Stated another way, the radial groove 202 extends around an inner periphery of the second flange 126. A retainer 206 is positioned in the radial groove 202. The retainer 206 is a ring. A disc 210 is positioned inside the countersink 194 and abuts the retainer 206. The disc 210 is biased against the retainer 206 by a disc biasing member 214. The disc biasing member 214 is positioned within the radial recess 198 and extends through the countersink 194 into contact with the disc 210. When the isolation valve assembly 46 is in a sealed position, as described in further detail below, the disc biasing member 214 forces the disc 210 downwards in opposition to the upward force of the third gasket 154 on the disc 210. The disc biasing members 214 thereby provide additional contact pressure between the disc 210 and third gasket 154 and thus improve the seal. In some embodiments, the disc 210 can be formed of a mechanically compliant material that stretches over the gasket 154 as the piston 106 moves from the sealed position to the evacuation position, which is described in further detail below.

With reference now to FIG. 6, an intermediate groove 218 is provided in the body 62. The intermediate groove 218 is radially positioned between the body groove 146 and the high vacuum groove 158. The intermediate groove 218 is recessed further into the body 62 than the body groove 146 and high vacuum groove 158. A pair of spring bores 222 are provided in the intermediate groove 218. The spring bores 222 are aligned halfway (i.e., 180 degrees) around the valve bore 134 from each other. Each spring bore 222 receives a respective piston biasing member 142 (shown in FIG. 5). The pair of second channels 86 are also provided in the intermediate groove 218. The second channels 86 are aligned halfway (i.e., 180 degrees) around the valve bore 134 from each other. Each second channel 86 is positioned adjacent a respective spring bore 222. An intermediate cutout 226 is further provided in the body 62. The intermediate cutout 226 extends along a portion of the intermediate groove 218. The intermediate cutout 226 fluidly connects the intermediate groove 218 and the backing channel 102. The backing channel 102 can be selectively fluidly connected to the second channels 86 through the intermediate groove 218 and the intermediate cutout 226. The backing channel 102, the intermediate groove 218, and the intermediate cutout 226 can together be referred to as an evacuation channel 230. The evacuation channel 230 is selectively fluidly connected to the second channels 86 by the evacuation valves 138 (shown in FIG. 5). Importantly, the pathways that make up the high vacuum channel 98 and evacuation channel 230 have a high molecular conductance.

With reference now to FIG. 7, the control valve 50 is in fluid communication with the low vacuum region 24, the first channel 78, and the atmosphere. The control valve 50 is coupled to the first port 74. In some embodiments, the control valve 50 is directly coupled on or mounted to the first port 74. In other embodiments, the control valve 50 is coupled to the first port 74 by a hose, a pipe, etc. The control valve 50 is fluidly connected to the low vacuum region 24 and the atmosphere by fluid connections (e.g., one or more hoses, pipes, etc.). In some embodiments, a valve (not shown) may be connected to a hose between the control valve 50 and the atmosphere. In some embodiments, the control valve 50 is only fluidly connected to the low vacuum region 24. In these embodiments, flow restrictors (not shown) can be positioned on each side of the piston 106. For example, a first flow restrictor can be placed between the control valve 50 and the isolation valve assembly 46 (i.e., in the first channel 78), and a second flow restrictor can be placed in the third channel 98. In other embodiments, the control valve 50 is fluidly connected with the vacuum interlock 34 instead of directly to the atmosphere. As such, the control valve 50 can be in fluid communication with the low vacuum region 24, the vacuum interlock 34, and the first channel 78.

The controller 54 is configured to adjust the control valve 50 between a first position and a second position. In the first position, the control valve 50 fluidly connects the first channel 78 with the atmosphere. In the first position, the first channel 78 is fluidly isolated from the low vacuum region 24. In the second position, the control valve 50 fluidly connects the first channel 78 with the low vacuum region 24. In the second position, the first channel 78 is fluidly isolated from the atmosphere. The air at atmospheric pressure has a greater pressure than the air in the low vacuum region.

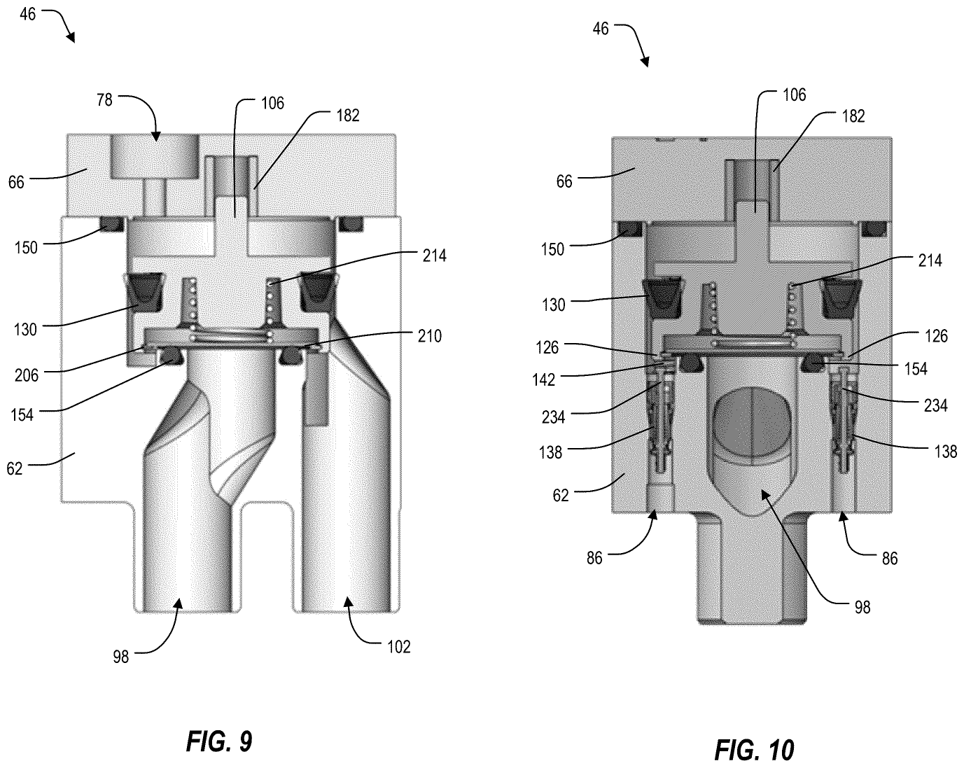

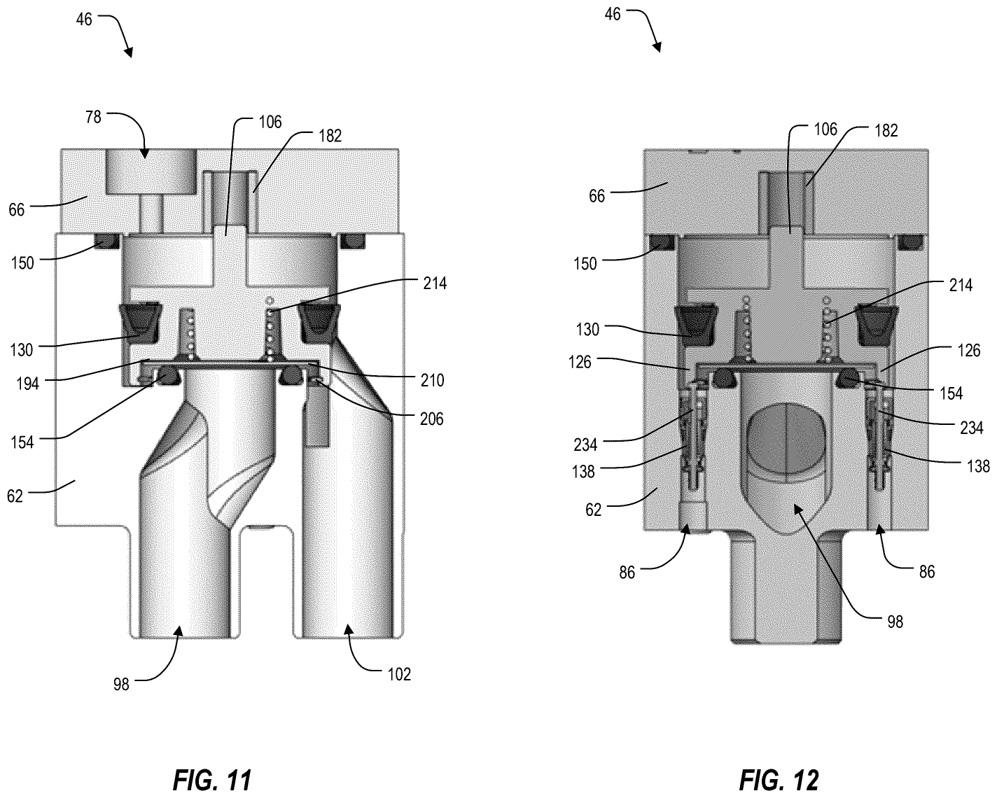

Adjustment of the control valve 50 moves the piston 106 between an opened position (also referred to as an open configuration or an operational configuration or an operation position) (shown in FIGS. 7 and 8), the sealed position (also referred to as a sealed configuration) (shown in FIGS. 9 and 10), and an evacuation position (also referred to as a closed configuration or an evacuation configuration) (shown in FIGS. 11 and 12). The piston 106 moves to the opened position in response to the control valve 50 being in the second position (e.g., when the first channel 78 is connected to the low vacuum region 24). The piston 106 moves to the evacuation position in response to the control valve 50 being in the first position (e.g., when the first channel 78 is connected to atmospheric pressure). The piston 106 moves to the sealed position as the piston 106 is moving between the opened position and the evacuation position (or between the evacuation position and the opened position).

With reference to FIG. 7, the piston 106 is in the opened position. In the opened position, the disc 210 is spaced away from the third gasket 154. In response, the high vacuum channel 98 is fluidly connected to the backing channel 102.

With reference now to FIG. 8, in the opened position the lower radial flange 126 of the piston 106 is spaced apart from a stem 234 of each evacuation valve 138. As such, each evacuation valve 138 is in the closed position. With each evacuation valve 138 in the closed position, the second channels 86 are fluidly isolated from the first channel 78, the high vacuum channel 98, and the backing channel 102. In some embodiments, each evacuation valve 138 can be replaced by a port located on the inner surface of the valve body 62 such that the open or closed state of the port is determined by the position of the piston and its seals within the bore 134.

The piston 106 is in the opened position in response to the control valve 50 being in the second position. With the control valve 50 in the second position, the first channel 78 is fluidly connected to the low vacuum region 24. As such, the first channel 78 is at the same pressure as the low vacuum region 24 (i.e., at the second vacuum). The second vacuum is at a sufficiently low pressure that does not overcome the biasing force of the piston biasing members 142. Stated another way, the biasing force of the piston biasing members 142 is greater than a force generated by the second vacuum. When the piston 106 is in the opened position, the high vacuum channel 98 is fluidly connected to the backing channel 102 and fluidly isolated from the first channel 78 and the second channels 86. With the piston 106 in the opened position, the mass spectrometer 10 can test the sample 40, which is discussed in greater detail below.

With reference now to FIG. 9, the piston 106 is in the sealed position. In the sealed position, the disc 210 contacts the third gasket 154. The disc 210 creates a seal with the third gasket 154 to fluidly isolate the high vacuum channel 98 from the backing channel 102. The disc 210 is not biased against a biasing force of the disc biasing member 214. As such, the disc 210 is in contact with both the retainer 206 and the third gasket 154.

With reference now to FIG. 10, the lower radial flange 126 of the piston 106 is spaced apart from the stem 234 of each evacuation valve 138. With each evacuation valve 138 in the closed position, the second channels 86 are fluidly isolated from the first channel 78, the high vacuum channel 98, and the backing channel 102. When the piston 106 is in the sealed position, each of the first channel 78, the second channels 86, the backing channel 102, and the high vacuum channel 98 are fluidly isolated from each other. As such, the high vacuum channel 98 is fluidly isolated from the first channel 78, the second channels 86, and the backing channel 102.

The piston 106 is in the sealed position when the control valve 50 has switched between the first and second positions. The piston 106 does not remain at the sealed position. Rather, the piston 106 is only temporarily at the sealed position when moving between the opened and evacuation positions.

With reference now to FIG. 11, the piston 106 is in the evacuation position. In the evacuation position, the disc 210 contacts the third gasket 154. The disc 210 forms a seal with the third gasket 154 to fluidly isolate the high vacuum channel 98 from the backing channel 102. The disc 210 is also biased against the biasing force of the disc biasing member 214. As such, the disc 210 is spaced apart from the retainer 206. However, the disc 210 is in contact with an inner portion of the piston 106. More specifically, the disc 210 is in contact with the countersink 194. The disc 210 is sandwiched between the third gasket 154 and the countersink 194.

With reference now to FIG. 12, the lower radial flange 126 of the piston 106 is in contact with the stem 234 of each evacuation valve 138. As such, each evacuation valve 138 is in the evacuation position. With each evacuation valve 138 in the evacuation position, the second channels 86 are fluidly connected with the backing channel 102. With reference back to FIG. 6, air can freely move through the second channels 86, the intermediate groove 218, the intermediate cutout 226, and the backing channel 102. Stated another way, air can freely move through the second channels 86 and the evacuation channel 230.

The piston 106 is in the evacuation position in response to the control valve 50 being in the first position. With the control valve 50 in the first position, the first channel 78 is fluidly connected to the atmosphere. As such, the first channel 78 is at atmospheric pressure. The atmospheric pressure is a sufficiently high pressure to overcome the biasing force of the piston biasing members 142. Stated another way, the atmospheric pressure is greater than the biasing force of the piston biasing members 142. Stated yet another way, removal of the vacuum from the first channel 78 is sufficient to overcome the biasing force of the piston biasing members 142. When the piston 106 is in the evacuation position, the high vacuum channel 98 is fluidly isolated from the first channel 78, the second channels 86, and the backing channel 102. The backing channel 102 is fluidly connected to the second channels 86. With the piston 106 in the evacuation position, the vacuum system can be evacuated, which is discussed in greater detail below.

In an embodiment, it may be desirable to enable a timed transition from the evacuation position to the open position that depends upon the relative pressure differential between sides of the piston 106. In such an embodiment, a small restrictor orifice can be positioned within a portion of the piston 106 such as disc 210, first flange 122, and/or second flange 126. When the first channel 78 is blocked and/or the control valve 50 or first port 72 between atmospheric pressure and the first channel 78 is a one-way valve, the restrictor orifice can enable a controlled leak from the atmospheric volume on one side of the piston 106 to the evacuation channel 230 on the other side of the piston 106. As the pressure equalizes between sides of the piston, a control force on the piston becomes less than the piston biasing member and the isolation valve assembly 46 switches from the evacuation position to the opened position.

As described above with reference to FIGS. 7-12, the isolation valve assembly 46 advantageously operates to seal the connection between the high vacuum pump 20 and the low vacuum region 24 during all times when air at atmospheric pressure could enter the system (such as when air is being purged or pumped from the vacuum interlock 34). By using the same piston 106 both to open/seal the connection between the third channel 98 and the fourth channel 102 (through contact of disc 210 and third gasket 154) and to open/seal the connection between the second channel 86 and the fourth channel 102 (through actuation of the evacuation valves 138), fluidic connections between different parts of the system are switched in a single operation by motion of the piston 106. In addition, the design of the piston 106 ensures that fluidic connections are always changed in the correct order to prevent exposure of the pressure surge to the high vacuum pump 20. As shown above, as the piston 106 moves from the open to sealed positions, the connection to the third channel 98 (i.e., the high vacuum pump 20) is closed first. After closure of the third channel 98 connection, the continued motion of the piston 106 opens the second channels 86 to connect the interlock (e.g., at atmospheric pressure) to the low vacuum region 24 to enable pumpdown of the interlock. Thus, the design of the isolation valve assembly 46 (including, for example, disc 201 biased by disc biasing member 214 and lower radial flange 126) ensures that isolation occurs in the proper two-step order during a single motion of the piston 106. Additionally, the motion of the piston 106 can be powered by a small control valve 50 and takes advantage of the pressure differential between atmosphere and the pressure within the vacuum system 12.

The isolation valve assembly 46 can also protect the high vacuum pump 20 without user interaction during loss of power such as might occur during an emergency or during shipment of an instrument under vacuum conditions. For example, the control valve 50 can be configured to default to the first position upon loss of power. Then, upon loss of power, the first channel 78 fills with air at atmospheric pressure. The resulting air pressure imbalance on the piston will force the piston 106 to travel to the evacuation position and to thus seal the third channel 98 to the high vacuum pump 20.

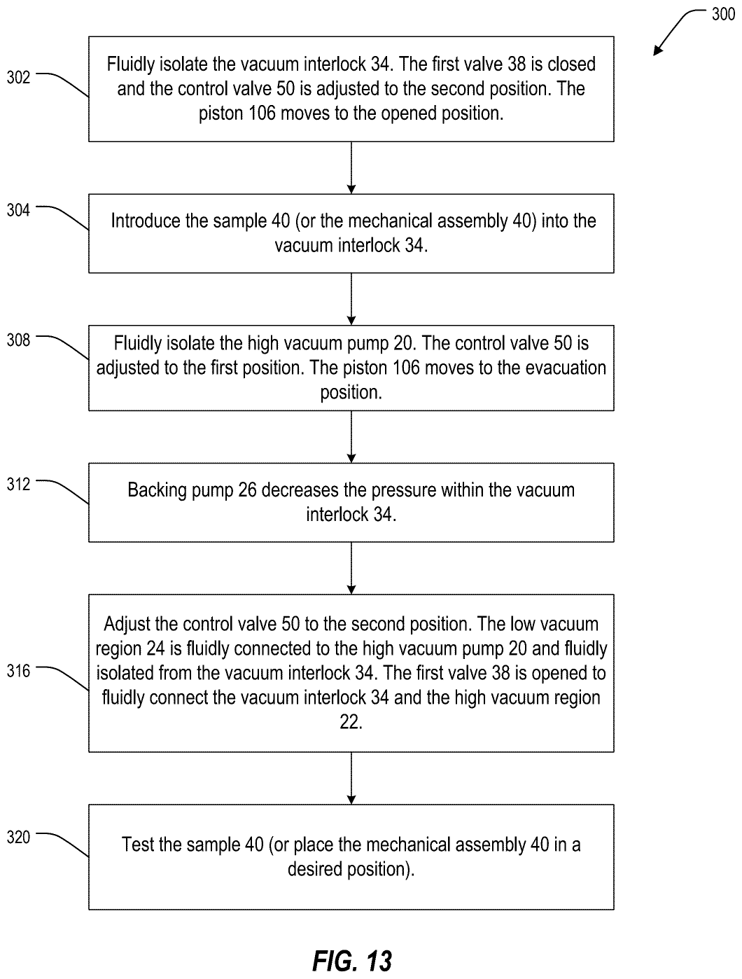

With reference to FIG. 13, an example of a process of operating the mass spectrometer 300 is illustrated. The process 300 includes a plurality of instructions or steps that are depicted in flow diagram form. The process 300 begins at step 302, in which vacuum interlock 34 is fluidly isolated from the high vacuum region 22 and the low vacuum region 24. The vacuum interlock 34 is fluidly isolated from the high vacuum region 22 by closing the high vacuum valve 38. The vacuum interlock 34 is fluidly isolated from the low vacuum region 24 by moving the control valve 50 to the second position, which moves the piston 106 to the opened position. With the piston 106 in the opened position, the evacuation valves 138 are in the closed position.

Next, at step 304, the sample 40 is introduced to the vacuum interlock 34. If step 304 occurs after a sample 40 has been previously tested, and the tool 42 is coupled to the vacuum interlock 34, the tool 42 is removed from the vacuum interlock 34 along with the previously tested sample 40. Removal of the tool 42 fills the vacuum interlock 34 with external air at atmospheric pressure. However, since the vacuum interlock 34 is fluidly isolated from the high and low vacuum regions 22, 24 the external air at atmospheric pressure is contained to the vacuum interlock 34. When filled with air at atmospheric pressure, the vacuum interlock 34 can be referred to as being at a starting pressure. Once the tool 42 is removed, the tool 42 can be cleaned, and any remaining material from the previously tested sample 40 can be removed. The tool 42 can then be reused, with a new sample 40 to be ionized being inserted into the tool 42. Alternatively, or additionally, a second tool 42 can carry a new sample 40 to be ionized. The tool 42 carrying the new sample 40 is then coupled to the vacuum interlock 34. Coupling the tool 42 to the vacuum interlock 34 seals the vacuum interlock 34 from the external air. The vacuum interlock 34 now includes the new sample 40, which is carried by the tool 42. The vacuum interlock 34 is then sealed at the starting pressure in response to insertion of the tool 42. Entering step 308, the vacuum interlock 34 includes the new sample 40.

Next, at step 308, the control valve 50 is adjusted from the second position to the first position. In response to the control valve 50 moving to the first position, the piston 106 moves from the opened position to the sealed position, and then to the evacuation position. The high vacuum pump 20 was previously isolated from the vacuum interlock 34 in step 302 by closing the first valve 38. Step 308 now results in the high vacuum pump 20 also being fluidly isolated from the low vacuum region 24. The high vacuum pump 20 is isolated to prevent damage to the high vacuum pump 20. The high vacuum pump 20 can be damaged by a pressure differential between the high vacuum pump 20 and the low vacuum region 24 or the vacuum interlock 34 that creates a rapid increase in pressure in the high vacuum pump 20. For example, the efficiency and integrity of the high vacuum pump 20 (such as a turbomolecular pump) can be harmed if the backing pressure is too high. The high vacuum pump 20 is isolated adjusting the control valve 50 to the first position. The control valve 50 is defaulted to the first position. This prevents damage to the high vacuum pump 20 during transport, power outages, etc. If the control valve 50 is not in the first position, the controller 54 adjusts the control valve 50 from the second position to the first position. As the control valve 50 is adjusted from the second position to the first position, the first channel 78 switches from fluid connection with the low vacuum region 24 to fluid connection with the atmosphere. The atmospheric pressure is greater than the pressure in the low vacuum region 24 (i.e., at the second vacuum). As such, the pressure in the first channel 78 increases rapidly in response to the control valve 50 adjusting from the second position to the first position. The rapid increase in pressure in the first channel 78 causes an increase in a control force upon the piston 106. The control force is exerted on the piston 106 in a direction opposite to a direction of the biasing force of the piston biasing members 142. The control force becomes greater than the biasing force of the piston biasing members 142. As such, the piston 106 is moved along the central axis 110 by the control force from the opened position to the sealed position. In the sealed position, the disc 210 creates the seal with the third gasket 154. Once the disc 210 contacts the third gasket 154, the control force continues to move the piston 106 along the central axis 110 into the evacuation position. However, the control force now moves the piston 106 against the biasing force of the piston biasing member 142 and the biasing force of the disc biasing member 214 to the evacuation position. In the evacuation position, the disc 210 is sandwiched between the countersink 194 and the third gasket 154. The pressure upon the disc 210 by the countersink 194 can improve the seal between the disc 210 and the third gasket 154. Accordingly, the disc 210 can have a better seal with the third gasket 154 in the evacuation position than in the sealed position. The lower radial flange 126 of the piston 106 contacts the stem 234 of each evacuation valve 138 to move the evacuation valves 138 to the evacuation position. The second channels 86 are now fluidly connected to the backing channel 102. Entering step 308, the high vacuum pump 20 is fluidly isolated from the low vacuum region 24 and the vacuum interlock 34.

Next, at step 312, the pressure in the vacuum interlock 34 is decreased by the backing pump 26. The pressure is reduced until the vacuum interlock 34 reaches a reduced operating pressure. The pressure in the vacuum interlock 34 is reduced to facilitate a transfer of the sample 40 from the vacuum interlock 34 to the high vacuum region 22. The operating pressure is not as low of a pressure as the first vacuum in the high vacuum region 22. However, the operating pressure is sufficiently low to not create a harmful pressure differential between the vacuum interlock 34 and the high vacuum region 22. The operating pressure can be a predetermined pressure value. The controller 54 can detect the pressure from the pressure sensor 30 to determine whether the vacuum interlock 34 is at the operating pressure. For example, once the pressure within the low vacuum region 24 has stabilized, the controller 54 can determine the vacuum interlock 34 is at the operating pressure. Alternatively, the controller 54 can wait until a pre-set or experimentally determined amount of time has passed that is sufficient to reduce from atmospheric to operating pressure. After this amount of time, the controller 54 may proceed to further steps in the method without measuring the level of the operating pressure. Entering step 316, the pressure in the vacuum interlock 34 is at the operating pressure.

Next, at step 316, the control valve 50 is adjusted from the first position to the second position and then the first valve 38 is opened. Step 316 results in the high vacuum pump 20 being fluidly connected to the low vacuum region 24 and the vacuum interlock 34. In response to the control valve 50 moving to the second position, the piston 106 moves from the evacuation position to the sealed position and to the opened position. The high vacuum pump 20 is fluidly connected to the low vacuum region 24 to exhaust gas into the low vacuum region 24. The high vacuum pump 20 is fluidly connected to the low vacuum region 24 by adjusting the control valve 50 from the first position to the second position. As the control valve 50 is adjusted from the first position to the second position, the first channel 78 switches from fluid connection with the atmosphere to fluid connection with the low vacuum region 24. The pressure in the low vacuum region 24 (i.e., at the second vacuum) is lower than the pressure in the atmosphere. As such, the pressure in the first channel 78 drops rapidly in response to the control valve 50 adjusting from the first position to the second position. The rapid drop in pressure in the first channel 78 creates a decrease in the control force upon the piston 106. The control force becomes smaller than the combined biasing force of the piston biasing members 142 and the disc biasing member 214. As such, the piston 106 is moved along the central axis 110 by the biasing force of the piston biasing members 142 from the evacuation position to the sealed position. In the sealed position, the lower radial flange 126 of the piston 106 moves out of contact with the stem 234 of each evacuation valve 138. The second channels 86 become fluidly isolated from the low vacuum region 24. The biasing force of the piston biasing members 142 continue to move the piston to the opened position. In the opened position, the high vacuum channel 98 and the backing channel 102 are fluidly connected. With the high vacuum and backing channels 98, 102 fluidly connected, the backing pump 26 is configured to receive the exhaust from the high vacuum pump 20 and remove it from the vacuum system 12 through the exhaust valve 28. The high vacuum pump 20 is then fluidly connected to the vacuum interlock 34 so the sample 40 can be inserted into the high vacuum region 22. The high vacuum pump 20 is fluidly connected to the vacuum interlock 34 by opening the first valve 38.

Next, at step 320, the sample 40 travels from the vacuum interlock 34 to the high vacuum region 22. The tool 42 can be extended to place the sample 40 within the high vacuum region 22. The sample 40 can then be ionized, accelerated through the ion guide 14, and tested. After the sample 40 has been tested, the tool 42 is retracted to return the sample 40 from the high vacuum region 22 back to the vacuum interlock 34.

Following the testing of the sample, the process of operating the mass spectrometer 300 can be repeated with a different sample 40. The process 300 returns to step 302, where the steps are sequentially repeated. It should be appreciated that completing steps 302 to 320 can be referred to as an operational cycle. As such, the process 300 with a first sample 40 can be referred to as a first operational cycle of a plurality of operational cycles. Following the first operational cycle, the process 300 with a second sample 40 can be referred to as a second operational cycle of the plurality of operational cycles. Following the second operational cycle, the process 300 with a third sample 40 can be referred to as a third operational cycle of the plurality of operational cycles. The third operational cycle can be followed by additional operational cycles to define a plurality of operational cycles.

The process 300 describes introducing and measuring the sample 40. It can be appreciated that the process 300 can alternatively be performed to complete a maintenance operation (e.g., exchange the cartridge of the ion source 14, the source plug, etc.). The process 300 will include similar steps that use the mechanical assembly 40 instead of the sample 40. For example, during a process of exchanging the cartridge of the ion source 14, in step 304, the cartridge is introduced into the vacuum interlock 34. In step 320, the cartridge replaces an old cartridge and is then mated with an ion guide.

Although the invention has been described in detail with reference to certain preferred embodiments, variations and modifications exist within the scope and spirit of one or more independent aspects of the invention as described. Various features and advantages of the invention are set forth in the following claims.

What is claimed is:

1. A vacuum system for a mass spectrometer, the vacuum system comprising:
a first vacuum region;
a second vacuum region;
a vacuum interlock fluidly connected to the first vacuum region by a first valve;
a first pump fluidly connected to the first and second vacuum regions, the first pump configured to decrease a pressure within the first vacuum region, the first pump configured to exhaust air to the second vacuum region;
a second pump fluidly connected to the second vacuum region, the second pump configured to decrease a pressure within the vacuum interlock; and
a second valve including:
a housing,
a piston movable within the housing between an evacuation position and an opened position,
a first channel extending through the housing and fluidly connected to a third valve, the third valve adjustable between a first position and a second position, the third valve fluidly connected to atmospheric air in the first position, the third valve fluidly connected to the second vacuum region in the second position,
a second channel extending through the housing and fluidly connected to the vacuum interlock,
a third channel extending through the housing and fluidly connected to the first pump, and
a fourth channel extending through the housing and fluidly connected to the second vacuum region,
wherein in response to the third valve adjusting to the first position, the piston moves to the evacuation position, the second channel is fluidly connected to the fourth channel, and the third channel is fluidly isolated from the first, second, and fourth channels, and
wherein in response to the third valve adjusting to the second position, the piston moves to the opened position, the third channel and the fourth channel are fluidly connected, and the third channel is fluidly isolated from the first and second channels.

2. The vacuum system of claim 1, wherein the second channel is a pair of second channels, the pair of second channels extending through the housing and fluidly connected to the vacuum interlock.

3. The vacuum system of claim 1, wherein the second channel includes a fourth valve adjustable between an opened position and a closed position.

4. The vacuum system of claim 3, wherein in response to the piston moving to the evacuation position, the piston contacts the fourth valve to adjust the fourth valve to the opened position, and wherein in response to the piston moving to the opened position, the piston releases the fourth valve to adjust the fourth valve to the closed position.

5. The vacuum system of claim 1, wherein the first channel is fluidly isolated from the second, third, and fourth channels.

6. The vacuum system of claim 5, wherein the piston includes a body, a first radial flange extending from the body, and a second radial flange extending from the housing, and wherein a gasket is position between the first and second radial flanges, the gasket configured to fluidly isolate the first channel from the second, third, and fourth channels.

7. The vacuum system of claim 1, wherein the piston is biased into the opened position by a biasing member.

8. The vacuum system of claim 7, wherein in response to the third valve adjusting to the first position, atmospheric air enters the first channel, and wherein the atmospheric air moves the piston against the bias of the biasing member to the evacuation position.

9. The vacuum system of claim 8, wherein the biasing member is a first biasing member, and wherein the piston includes a piston housing defining a piston cavity, a disc positioned in the piston cavity, and a second biasing member positioned within the piston cavity and biasing the disc away from the piston housing.

10. The vacuum system of claim 9, further comprising a gasket on an internal end of the third channel, the disc configured to contact the gasket and create a seal with the gasket.

11. The vacuum system of claim 10, wherein
in response to the third valve adjusting to the first position, atmospheric air enters the first channel,
the piston is moved against the bias of the first biasing member by the atmospheric air, and
the disc is moved into contact with the gasket by the atmospheric air.

12. The vacuum system of claim 11, wherein in response to atmospheric air entering the first channel, the disc is moved against the bias of the second biasing member.

13. The vacuum system of claim 12, wherein
the second channel includes a fourth valve adjustable between an opened position and a closed position,
in response to the piston contacting the fourth valve, the fourth valve is adjusted to the opened position, and
in response to the fourth valve adjusting to the opened position, the piston is in the evacuation position.

14. The vacuum system of claim 13, wherein the disc creates a seal with the gasket, and wherein in response to the disc creating a seal with the gasket, the third channel is fluidly isolated from the first, second, and fourth channels.

15. The vacuum system of claim 1, wherein
the housing includes a first end and a second end opposite the first end,
the first channel extends through the first end, and
the second, third, and fourth channels extend through the second end.

16. A valve assembly comprising:
a housing including a body and a cap coupled to the body;
a piston movable within the housing between an evacuation position and an opened position;
a first channel extending through the cap;
a second channel extending through the body;
a third channel extending through the body; and
a fourth channel extending through the body;
wherein in response to the piston moving to the evacuation position, the second channel is fluidly connected to the fourth channel, and the third channel is fluidly isolated from the first, second, and fourth channels, and
wherein in response to the piston moving to the opened position, the third channel and the fourth channel are fluidly connected, and the third channel is fluidly isolated from the first and second channels.

17. The valve assembly of claim 16, wherein the second channel is a pair of second channels, the pair of second channels extending through the body.

18. The valve assembly of claim 16, wherein
the second channel includes a valve adjustable between an opened position and a closed position,
in response to the piston moving to the evacuation position, the piston contacts the valve to adjust the valve to the opened position, and
in response to the piston moving to the opened position, the piston releases the valve to adjust the valve to the closed position.

19. The valve assembly of claim 16, wherein the piston includes a piston body, a first radial flange extending from the piston body, and a second radial flange extending from the housing, and wherein a gasket is position between the first and second radial flanges, the gasket configured to fluidly isolate the first channel from the second, third, and fourth channels.

20. The valve assembly of claim 16, wherein the piston is biased into the opened position by a first biasing member, and wherein the piston includes a piston housing defining a piston cavity, a disc positioned in the piston cavity, and a second biasing member positioned within the piston cavity and biasing the disc away from the piston housing.
